(19) United States
(12) Patent Application Publication
(10) Pub. No.: US 2026/0320176 A1
(43) Pub. Date: Oct. 15, 2026

(54) MANAGEMENT VIRTUAL SECURITY PROCESSOR IN A PLATFORM CONTROLLER

(71) Applicant: HEWLETT PACKARD ENTERPRISE DEVELOPMENT LP, Spring, TX (US)

(72) Inventor: Robert C. Elliott, Austin, TX (US)

(21) Appl. No.: 19/175,933

(22) Filed: Apr. 10, 2025

(51) Int. Cl. G06F 21/54; G06F 21/60; G06F 21/85

(52) U.S. Cl. CPC G06F 21/54; G06F 21/602; G06F 21/85

(57) ABSTRACT

In some examples, a platform controller includes a processing resource and a management virtual security processor executable by the processing resource to present an interface accessible to a virtual entity controller in a computer system. The computer system includes a central processing unit (CPU) separate from the platform controller. The virtual entity controller manages a virtual compute entity in the computer system. The management virtual security processor can interact with the virtual entity controller through the interface to perform a management task related to a client virtual security processor for the virtual compute entity.

### BACKGROUND

A computer system includes various electronic components, such as a processor, a memory, a persistent storage, a network interface controller, and so forth. Machine-readable instructions, including software programs and/or firmware programs, can be executed on the processor.

### BRIEF DESCRIPTION OF THE DRAWINGS

Some implementations of the present disclosure are described with respect to the following figures.

FIG. 1A is a block diagram of a computer system including a platform controller with a management virtual trusted platform module (vTPM) according to some examples.

FIG. 1B is a block diagram of a computer system including a platform controller with vTPMs accessible over different buses, according to further examples.

FIG. 2 is a flow diagram of a process involving a hypervisor, the measurement vTPM, and a virtual machine (VM), according to some examples.

FIG. 3 is a block diagram of a platform controller according to some examples.

FIG. 4 is a block diagram of a storage medium storing machine-readable instructions according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A computer system can include a security processor (sometimes referred to as a security cryptoprocessor) that can perform various security functions to make the computer system more secure against attacks or unauthorized access. The security functions of the security processor can include key and certificate management and generation. For example, the security processor can use and securely store cryptographic keys used in security operations. An example of a security processor is a Trusted Platform Module (TPM). In some examples, the TPM operates according to a security specification defined by the Trusted Computing Group (TCG). In other examples, a TPM can operate according to other standards, open-source protocols, or proprietary protocols.

In some cases, a TPM can be implemented using hardware, such as with an integrated circuit (IC) chip. In other cases with computer systems that implement virtualization, virtual TPMs (vTPMs) can be used for virtual compute entities executing in the computer systems. The vTPMs emulate physical TPMs. Examples of virtual compute entities include virtual machines (VMs), containers, or other types of virtual compute entities. To reduce the load on a central processing unit (CPU) of a computer system, TPM emulation can be performed by a separate processing resource (separate from the CPU) so that vTPMs are executed by the separate processing resource. This separate processing resource can be referred to as a "platform controller," which is a controller that performs specified tasks in the computer system with the specified tasks being different from those of primary machine-readable instructions executed by the CPU.

A challenge associated with providing vTPMs (or other types of virtual security processors) in a platform controller is that a management entity has to coordinate with the platform controller to perform various management tasks associated with the vTPMs, including one or more of: creating the vTPMs, removing the vTPMs, assigning the vTPMs to respective virtual compute entities, loading vTPM state information to the vTPMs, or obtaining vTPM state information from the vTPMs. In some cases, a cloud-based manager (or orchestrator) is provided in a cloud environment to remotely interact with a platform controller and a hypervisor of the computer system to perform the foregoing management tasks associated with vTPMs. However, using the cloud-based manager to perform management tasks associated with the vTPMs can increase complexity as a path, e.g., an application programming interface (API) or another type of interface, would have to be provided between the cloud-based manager and the platform controller.

In accordance with some implementations of the present disclosure, a platform controller can present a virtual security processor management interface to an internal virtual entity controller in a computer system so that the virtual entity controller can perform management tasks associated with virtual security processors such as vTPMs, virtual hardware security modules (HSMs), or other types of virtual security processors. In examples where the computer system includes VMs, the virtual entity controller can include a hypervisor that creates and manages VMs. In other examples where the computer system includes containers, the virtual entity controller can include a container manager, such as a Docker, containerd, a Kubernetes Container Runtime Interface (CRI), or any other container manager.

The virtual security processor management interface can be presented by a management virtual security processor, such as a management vTPM, a management virtual HSM, and so forth, running in the platform controller. The virtual entity controller can interact with the management virtual security processor based on (1) the virtual entity controller issuing management commands (through the virtual security processor management interface) to the management virtual security processor, or (2) the management virtual security processor sending management objects (through the virtual security processor management interface) to the virtual entity controller. Examples of management commands issued by the virtual entity controller to the management virtual security processor can include any or some combination of the following: a create command to create a client virtual security processor in the platform controller; a delete command to remove (destroy) a client virtual security processor (e.g., a client vTPM) of the platform controller; a start command to assign a virtual security processor to a virtual compute entity (e.g., assign a client vTPM to a VM); a stop command to unassign the client virtual security processor from a virtual compute entity; a migrate command to reassign a client virtual security processor to a different virtual compute entity (e.g., reassign a client vTPM initially assigned to a first VM to a different second VM, such as due to a fault of the first VM or another issue); a load command to load state information to a client virtual security processor; or an unload command to unload state information from a client virtual security processor. In some cases, a management command sent to the management virtual security processor can cause multiple management actions, such as assigning a virtual security processor to a virtual compute entity and loading state information to the virtual security processor, or unassigning the virtual security processor from the virtual compute entity and unloading state information from the virtual security processor.

A "client virtual security processor" refers to a virtual security processor used by a virtual compute entity. For example, a "client vTPM" is a vTPM used by a respective VM.

Examples of management objects sent from the management virtual security processor to the virtual entity controller can include any or some combination of the following: an update object containing an updated state of a client virtual security processor (e.g., an updated vTPM state) in the platform controller; or an interrupt object to announce when a state update is available for a client virtual security processor.

In some examples, the virtual security processor management interface can include a management API presented by the management virtual security processor. Alternatively, the virtual security processor management interface can include another type of interface, such as an inter-process interface between the virtual entity controller and the management virtual security processor, a shared memory through which management commands and management objects can be exchanged, or another type of interface.

Techniques or mechanisms according to some examples of the present disclosure can improve computer functionality or the relevant technology by improving the efficiency and reducing the complexity of managing client virtual security processors for virtual compute entities in a computer system. An external path from a platform controller to an external management entity, such as a cloud-based manager, does not have to be implemented to perform management of client virtual security processors. Rather, an internal path between the platform controller and an internal virtual entity controller can be employed. For example, the path can use a virtual security processor management interface presented by a management virtual security processor, and the path can include a bus that is connected to the platform controller. The bus may be a Peripheral Component Interconnect Express (PCIe) bus, an Enhanced Serial Peripheral Interface (eSPI) bus, a Compute Express Link (CXL) bus, or any other type of interconnect between electronic components in a computer system.

Additionally, the management of client virtual security processors using a management virtual security processor in a platform controller can be performed in a secure manner since the management virtual security processor can be used to verify the virtual entity controller (e.g., a hypervisor), to ensure the virtual entity controller has not been compromised.

In the ensuing discussion, reference is made to VMs as examples of virtual compute entities, a hypervisor as an example of a virtual entity controller for the VMs, and vTPMs as examples of virtual security processors. Similar techniques or mechanisms can be applied for other types of virtual security processors and/or for other types of virtual compute entities and virtual entity controllers.

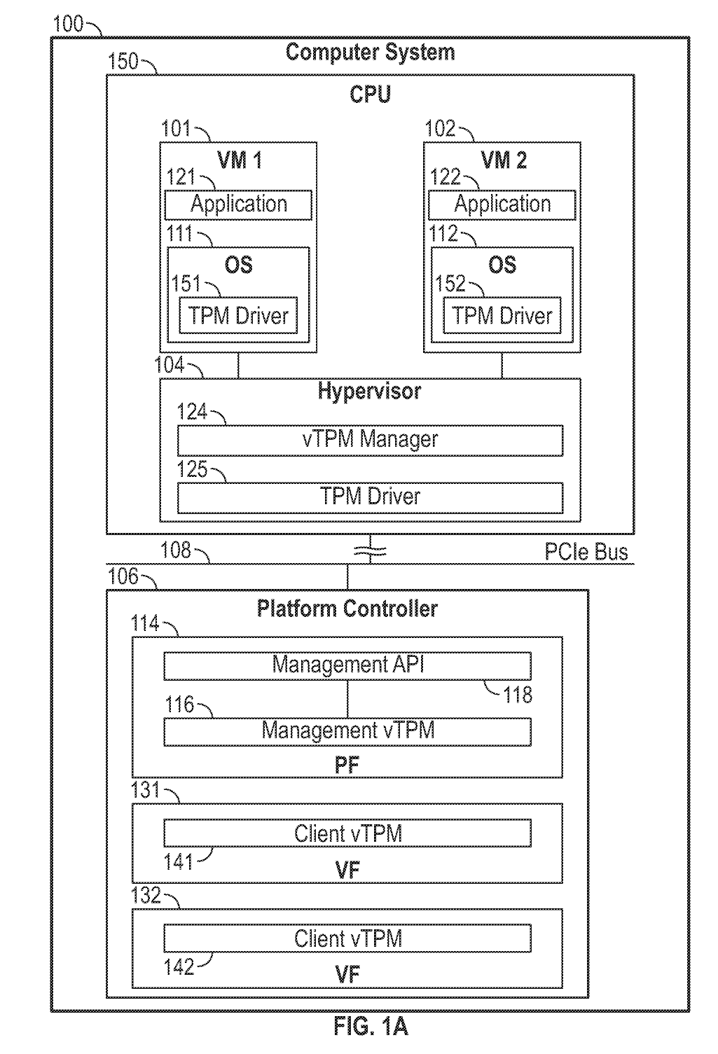

FIG. 1A is a block diagram of a computer system 100, which can include one or more computers. The computer system 100 includes a CPU 150, which has one or more hardware processors of the one or more computers. The CPU 150 executes VMs 101 and 102 and a hypervisor 104. Although two VMs are shown in FIG. 1A, a different quantity (less than two or more than two) of VMs may be present in the computer system 100. VMs can be started on demand by a user or another entity. The computer system 100 can start with zero VMs, and additional VM(s) is (are) started when requested.

The CPU 150 can also execute other machine-readable instructions, such as a host OS (if present), boot code (e.g., Basic Input/Output System (BIOS) code or Universal Extensible Firmware Interface (UEFI) code), and/or other primary machine-readable instructions. The CPU 150 is coupled to a bus 108, either directly or through another device, such as a bridge device. In some examples, the bus 108 can be a PCIe bus, a CXL bus, or any other type of communication link.

Each VM includes a respective guest OS. The VM 101 includes a guest OS 111, and the VM 102 includes a guest OS 112. Examples of the guest OSes include a LINUX OS, a WINDOWS OS, and/or other types of OSes. The different guest OSes 111 and 112 can be of the same type or of different types. Each VM can also include a respective application program (or multiple application programs) executing in the VM. For example, the VM 101 includes an application program 121, and the VM 102 includes an application program 122.

The hypervisor 104 creates VMs, manages execution of VMs, emulates physical resources of the computer system 100 that are accessible by VMs, provides isolation between VMs, and performs other virtualization tasks. Physical resources that can be emulated by the hypervisor 104 for a VM include any or some combination of the following: a processing resource, a memory, a storage device, a communication interface, an input/output (I/O) device, or any other type of physical resource.

In some examples, the computer system 100 can include a physical TPM (not shown), which may be connected to the bus 108. Additionally or alternatively, the computer system 100 can also include vTPMs that emulate a physical TPM. Instead of emulating a TPM using the hypervisor 104, TPM emulation can be offloaded to a platform controller 106 of the computer system 100. In some examples, the platform controller 106 is a bus device on the bus 108.

The platform controller 106 is separate from the CPU 150. The machine-readable instructions executable by the platform controller 106 are separate and distinct from primary machine-readable instructions (e.g., a host OS, a boot code, etc.) and the VMs 101 and 102 executed by the CPU 150.

In some examples in which the bus 108 is a PCIe bus, TPM emulation can be performed using PCI functions implemented in the platform controller 106. In some examples, the PCI functions include virtual functions (VFs) 131 and 132 provided by PCIe single root I/O virtualization (SR-IOV), as defined by the PCI Special Interest Group (PCI-SIG), which is a community that defines standards relating to PCIe. SR-IOV is an extension to the PCIe Specification. SR-IOV allows a PCIe device (such as the platform controller 106 of FIG. 1A) to present itself to a host (e.g., the computer system 100) as multiple distinct virtual devices (e.g., the VFs 131 and 132).

The hypervisor 104 can assign a PCI function (or multiple PCI functions) to each VM. In the example of FIG. 1A, the hypervisor 104 can assign the VF 131 to the VM 101, and assign the VF 132 to the VM 102. The VFs 131 and 132 contain respective client vTPMs 141 and 142.

The platform controller 106 also implements a PCI physical function (PF) 114, which supports the SR-IOV interface of the platform controller. The PF 114 includes the SR-IOV extended capability in the PCIe configuration space, and this capability can be used to configure and manage the SR-IOV functionality of the platform controller 106, such as enabling virtualization and exposing the VFs 131 and 132. Effectively, the PF 114 can be used to expose the VFs 131 and 132 for the purpose of sharing the resources of the platform controller 106 in a virtual environment.

For example, the PF 114 can communicate information that allows a host, such as the hypervisor 104 in the computer system 100, to discover and control the VFs 131 and 132. A first information element that can be sent by the PF 114 indicates how many VFs the platform controller 106 supports (e.g., the maximum quantity of VFs that the platform controller 106 can support). A second information element can be adjusted by the hypervisor 104 to allow the hypervisor 104 to choose how many VFs are activated in the platform controller 106. A third information element that can be sent by the PF 114 is a class code of each VF indicating that the VF implements a TPM functionality, in the form of a client vTPM (e.g., 141 or 142). Further information elements sent by the PF 114, such as to the hypervisor 104, can indicate memory addresses for the VFs. For example, the further information elements can include a VF base address register (BAR) that specifies a base address for the VFs, and VF numbers of the activated VFs. A base address can be used to derive the starting address of a memory region (in the platform controller 106) at which a respective VF is accessible. For example, the starting address for the respective VF can be derived based on the base address of the VF BAR and a VF number of the respective VF (e.g., based on multiplying the base address by the VF number or based on another type of aggregation of the base address and the VF number). Although example information elements are listed above, in other examples, the PF 114 can communicate alternative or additional information elements to the hypervisor 104.

The PF 114 and the VFs 131 and 132 share physical resources of the platform controller 106, including a memory, a communication interface, and a processing resource. Once a VF is created in the platform controller 106, a VM to which the VF is assigned can communicate with the VF at the starting address that can be derived using the base address of the VF BAR and the VF number of the VF. In some examples of the present disclosure, a VM can communicate with a vTPM in the VF of the platform controller 106.

In accordance with some implementations of the present disclosure, the PF 114 includes a management vTPM 116 that presents a management API 118 through which the hypervisor 104 can interact with the management vTPM 116 to perform management tasks with respect to the client vTPMs 141 and 142 executing on the platform controller 106. The platform controller 106 can assign a specific class code to the PF 114 to indicate that the PF 114 implements the functionality of a TPM, in the form of the management vTPM 116. When the platform controller 106 is initially started during a boot process of the computer system 100, the platform controller 106 provides the PF's class code to the hypervisor 104 to indicate the TPM functionality provided by the PF 114.

The hypervisor 104 includes a vTPM manager 124 that can interact with the management API 118 presented by the management vTPM 116 to perform management tasks related to client vTPMs in the platform controller 106, including the client vTPMs 141 and 142. The hypervisor 104 further includes a TPM driver 125 to allow the hypervisor 104 to interact with the management vTPM 116.

The guest OS of each VM also includes a respective TPM driver to allow the VM to interact with a client vTPM assigned to the VM. The guest OS 111 includes a TPM driver 151, and the guest OS 112 includes a TPM driver 152.

FIG. 1B is a block diagram of a computer system 160 according to further examples of the present disclosure. Components with similar functionalities as those in FIG. 1A are assigned the same reference numerals in FIG. 1A. For example, the CPU 150 of the computer system 160 in FIG. 1B similarly executes VMs 101, 102, and the hypervisor 104.

The computer system 160 includes a platform controller 162 that has interfaces to connect the platform controller 162 to both the PCIe bus 108 and an eSPI bus 164. The PF 114 and the VFs 131 and 132 are connected to the PCIe bus 108. The CPU 150 is also connected (directly or indirectly) to the PCIe bus 108 and the eSPI bus 164.

The platform controller 162 further includes an eSPI endpoint 166 connected to the eSPI bus 164. The eSPI endpoint 166 includes an eSPI management vTPM 168 that presents an eSPI management API 170 accessible to the hypervisor 104, such as for performing management tasks with respect to the client vTPMs 141 and 142. In such examples, the hypervisor 104 can elect to use either (1) the management vTPM 116 of the PF 114 accessible over the PCIe bus 108 to manage the client vTPMs 141 and 142, or (2) the eSPI management vTPM 168 of the eSPI endpoint 166 accessible over the eSPI bus 164 to manage the client vTPMs 141 and 142.

Further, the eSPI endpoint 166 is available during boot of the computer system 160, so that boot code of the computer system 160 can access the eSPI management vTPM 168 during the boot of the computer system 160. The management vTPM 116 of the PF 114 is available at a later time after the availability of the eSPI management vTPM 168.

In some examples, the eSPI management vTPM 168 may be used to manage the management vTPM 116 of the PF 114. In other examples, the management vTPM 116 of the PF 114 may be used to manage the eSPI management vTPM 168.

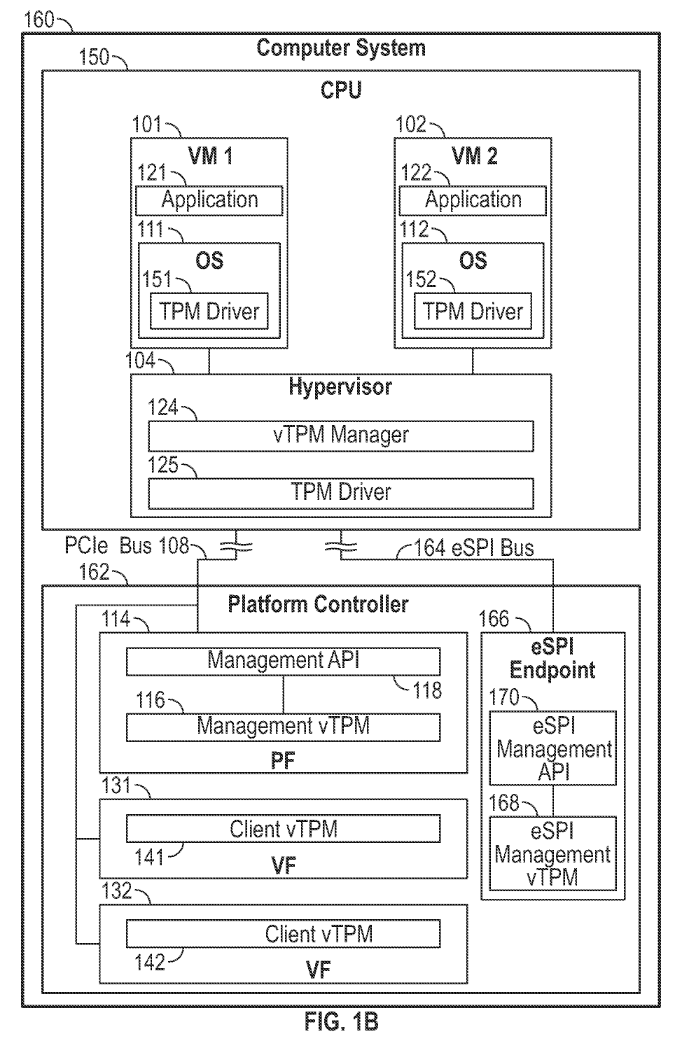

The following refers to both FIGS. 1A and 2. FIG. 2 is a flow diagram of a process involving the hypervisor 104, the platform controller 106, and the VM 101. A similar process can be performed with the VM 102 or any other VM. Also, a similar process can be performed using the arrangement of FIG. 1B.

The hypervisor 104 detects (at 202) the management vTPM 116 provided by the PF 114 of the platform controller 106. For example, when the platform controller 106 starts, the platform controller 106 can provide the class code of the PF 114 to indicate the TPM functionality provided by the PF 114. Based on this class code, the hypervisor 104 can determine that a management vTPM is provided by the PF 114.

The PF 114 in the platform controller 106 sends (at 204) information of VFs (e.g., 131 and 132) in the platform controller 106. The information can include the various information elements discussed further above, including the first information element indicating how many VFs are supported, the second information element indicating a quantity of VFs to be activated (this second information element can be set by the hypervisor 104), a third information element setting the class code of each VF to indicate that the VF implements a TPM functionality, and information elements indicating memory addresses the VFs.

In response to a request to start the VM 101, the vTPM manager 124 in the hypervisor 104 can interact (at 206) with the management vTPM 116 of the PF 114 in the platform controller 106 to start the client vTPM 141 and assign the client vTPM 141 to the VM 101. For example, the vTPM manager 124 can issue a create command to the management API 118 of the management vTPM 116 to create the client vTPM 141. As a further example, the vTPM manager 124 can issue a start command to the management API 118 to assign the client vTPM 141 to the VM 101. In further examples, instead of using separate create and start commands, a single command can be issued by the vTPM manager 124 to create and assign the client vTPM 141 to the VM 101.

As part of assigning the client vTPM 141 to the VM 101, the vTPM manager 124 can also load vTPM state information to the client vTPM 141. This can be performed in response to the start command or another command issued by the vTPM manager 124 to the management API 118. The vTPM state information loaded to the client vTPM 141 can include any or some combination of the following: (1) nonvolatile vTPM state information that includes security information such as cryptographic keys and/or other secrets, (2) volatile vTPM state information including content of platform configuration registers (PCRs) of the client vTPM 141, or (3) instance metadata that represents instance-specific information and user-specific information that can be used to configure the VM 101 at startup. Examples of instance-specific information can include any or some combination of an identifier of the VM 101, an identifier of a virtual device that contains a root file system, a host name of the VM 101, an Internet Protocol (IP) address of the VM 101, and so forth. The user-specific information may include a Secure Shell (SSH) key or another user credential that allows a user to securely communicate with the VM 101.

A PCR in a vTPM is a storage location to store predefined values, such as measurements (e.g., hashes) of information in a VM (e.g., the VM 101). For example, the hypervisor 104 or another security entity of the computer system 100 can apply a cryptographic hash function, such as a Secure Hash Algorithm (SHA) function, to the VM information to produce a hash value that can be extended to the PCR. Extending the hash value to the PCR includes performing an extend operation that calculates a cryptographic hash of a combination of the current value in the PCR with a new hash value based on the VM information. The content of the PCR in the client vTPM 141 can be used to later attest the VM 101 to verify the integrity of the VM 101.

The management vTPM 116 may similarly include PCRs, including a PCR to store measurements (e.g., hashes) of information of the hypervisor 104. Such measurements may be used to attest the hypervisor 104 to verify the integrity of the hypervisor 104, such as after the hypervisor 104 detects (at 202) the management vTPM 116 and before the hypervisor 104 interacts with the management vTPM 116 to perform management tasks with respect to the client vTPMs.

The hypervisor 104 sends (at 208) information of the client vTPM 141 to the VM 101. For example, the information can include a base address of a VF BAR and a VF number of the VF 131. This information can be used by the VM 101 to interact (at 210) with the client vTPM 141 in the platform controller 106. The interaction with the client vTPM 141 is to allow the VM 101 to initiate an attestation process to attest the VM 101. The attestation process can be performed between the VM 101 and a verifier, which may execute in the computer system 100 or outside the computer system 100. As an example, the VM 101 can include an attestation module to request measurements from the PCRs of the client vTPM 141. The measurements can be sent by the attestation module in the VM 101 to the verifier for use in determining whether the VM 101 has been compromised.

To access the client vTPM 141, the TPM driver 151 in the guest OS 111 of the VM 101 can write a TPM command for execution to the address of the client vTPM 141, where the address can be derived using the BAR base address and the VF number of the VF 131 including the client vTPM 141. The TPM command can be written to a control area (of a memory in the platform controller 106) referred to by the address. The TPM command can invoke an access operation and/or other operations relating to the client vTPM 141. The TPM driver 151 can receive a result of the TPM command from the client vTPM 141. The result may be retrieved by the TPM driver 151 from another memory area that stores TPM command results.

The vTPM manager 124 can subsequently perform (at 212) further management tasks with respect to the client vTPM 141. Examples of such further management tasks include unassigning the client vTPM 141 from the VM 101, removing or destroying the client vTPM 141, unloading vTPM state information from the client vTPM 141, or reassigning the client vTPM 141 to a different VM (different from the VM 101).

The management vTPM 116 can also send (at 214) a management object to the vTPM manager 124. The management object can be sent through the management API 118, for example. The management object sent can include an update object containing updated vTPM state information of the client vTPM 141. The updated vTPM state information contained in the update object may be encrypted by the management vTPM 116 using an encryption key to prevent unauthorized access of the updated vTPM state information during transfer from the platform controller 106 to the hypervisor 104. Also, the hypervisor 104 treats the updated vTPM state information as an opaque object when storing the updated vTPM state information; the hypervisor 104 cannot decrypt the updated vTPM state information or create new vTPM state information.

Another management object may include an interrupt signal (e.g., in the form of a packet or another indicator) to announce when a vTPM state update is available for the client vTPM 141. In response to the interrupt object, the vTPM manager 124 can access the management vTPM 116 to retrieve the updated vTPM state information. Alternatively, instead of using the interrupt object, the management vTPM 116 can push updated vTPM information in the update object to the vTPM manager 124 whenever the vTPM state information changes.

The hypervisor 104 then starts (at 216) the VM 101. The starting of the VM is in response to a request from a requester (a user, a program, or a machine), for example, or in response to another event of the computer system 100.

In alternative examples in which the arrangement of FIG. 1B is used, the hypervisor 104 can perform similar tasks as in FIG. 2, except that the hypervisor 104 may interact with either the management vTPM 116 of the PF 114 or the eSPI management vTPM 168 of the eSPI endpoint 166.

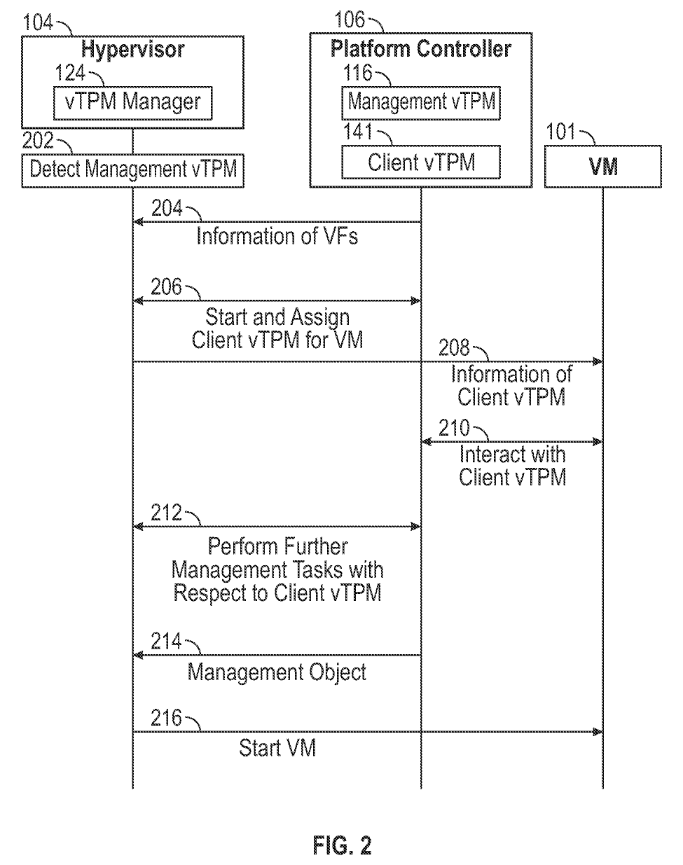

FIG. 3 is a block diagram of a platform controller 300 according to some examples of the present disclosure. An example of the platform controller 300 is the platform controller 106 of FIG. 1A or 162 of FIG. 1B. The platform controller 300 can be implemented using a management controller such as a baseboard management controller (BMC) or another type of controller, such as a smart network interface controller (NIC) or another controller.

The platform controller 300 includes a processing resource 302 separate from the CPU 150 that executes primary machine-readable instructions and VMs. The processing resource 302 can include one or more hardware processors. A hardware processor can include a microprocessor, a core of a multi-core microprocessor, a microcontroller, a programmable integrated circuit, a programmable gate array, or another hardware processing circuit.

The platform controller 300 further includes a management virtual security processor 304 executable by the processing resource 302 to perform various tasks. An example of the management virtual security processor 304 is the management vTPM 116 of FIGS. 1A or 1B or the eSPI management vTPM 168 of FIG. 1B. In other examples, the management virtual security processor 304 can include a management virtual HSM or another type of management virtual security processor.

The tasks of the management virtual security processor 304 include a management interface presentation task 306 to present an interface accessible to a virtual entity controller in a computer system. An example of the interface is the management API 118 of FIGS. 1A or 1B or the eSPI management API 170 of FIG. 1B. An example of the virtual entity controller is a hypervisor. The computer system includes a CPU (e.g., 150 in FIGS. 1A or 1B) separate from the platform controller 300, where the virtual entity controller manages a virtual compute entity (e.g., a VM) in the computer system.

The tasks of the management virtual security processor 304 include a virtual entity controller interaction task 308 to interact with the virtual entity controller through the interface to perform a management task related to a client virtual security processor for the virtual compute entity. The client virtual security processor can include a client vTPM, for example.

In some examples, the management virtual security processor 304 can receive, from the virtual entity controller, a management command relating to assigning the client virtual security processor to or unassigning the client virtual security processor from the virtual compute entity. In response to the management command, the management virtual security processor 304 can assign the client virtual security processor to or unassign the client virtual security processor from the virtual compute entity.

In some examples, the management virtual security processor 304 can receive, from the virtual entity controller, a management command relating to loading state information to or unloading state information from the client virtual security processor. In response to the management command, the management virtual security processor 304 can load the state information to or unload the state information from the client virtual security processor.

In some examples, the state information includes any or some combination of: a cryptographic key used by the client virtual security processor, a measurement value (e.g., a hash generated by a cryptographic hash function) for use in attesting an electronic component of the computer system, or instance metadata for a virtual compute entity.

In some examples, the management virtual security processor 304 can receive, from the virtual entity controller, a management command relating to creating the client virtual security processor or removing the client virtual security processor in the platform controller. In response to the management command, the management virtual security processor 304 can create or remove the client virtual security processor in the platform controller.

In some examples, the management virtual security processor 304 can send, to the virtual entity controller, a management object including updated state information (e.g., updated vTPM state information) of the client virtual security processor.

In some examples, the updated state information in the management object sent to the virtual entity controller is encrypted.

In some examples, the management virtual security processor 304 can send, to the virtual entity controller, a management object including an indicator (e.g., an interrupt signal) that state information of the client virtual security processor has been updated.

In some examples, the management virtual security processor 304 is part of a PCI PF (e.g., 114 in FIG. 1A) or an eSPI endpoint (e.g., 166 in FIG. 1B) of the platform controller 300.

In some examples, the platform controller 300 can provide, to the virtual entity controller, a class code indicating that the PF implements virtual security processor functionality.

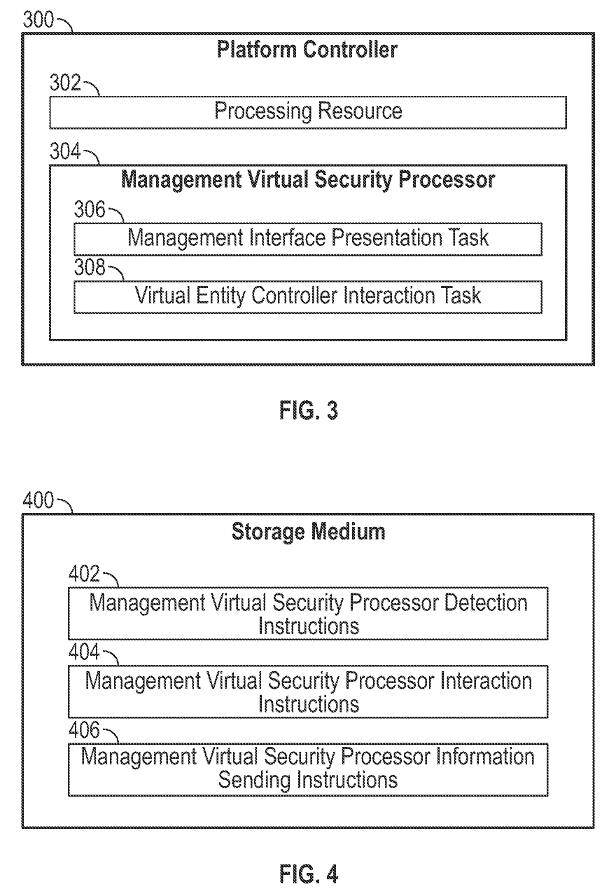

FIG. 4 is a block diagram of a non-transitory machine-readable or computer-readable storage medium 400 storing machine-readable instructions that upon execution cause a system to perform various tasks. The system may be the computer system 100 of FIG. 1A or the computer system 160 of FIG. 1B, for example.

The machine-readable instructions include management virtual security processor detection instructions 402 to detect a management virtual security processor executed by a platform controller that is separate from a CPU executing a virtual compute entity. The management virtual security processor may be the management vTPM 116 of FIGS. 1A or 1B or the eSPI management vTPM 168 of FIG. 1B, for example.

The machine-readable instructions include management virtual security processor interaction instructions 404 to interact with the management virtual security processor through an interface presented by the management virtual security processor to assign a client virtual security processor in the platform controller to the virtual compute entity. The interface may be the management API 118 of FIGS. 1A or 1B or the eSPI management API 170 of FIG. 1B, for example.

The machine-readable instructions include management virtual security processor information sending instructions 406 to send, to the virtual compute entity, information of the management virtual security processor to allow the virtual compute entity to interact with the management virtual security processor for a security operation. For example, the information can allow the virtual compute entity to derive a memory address relating to the client virtual security processor in the platform controller.

In some examples, the detecting of the management virtual security processor, the interacting with the management virtual security processor, and the sending of the information to the virtual compute entity are performed by a hypervisor.

In some examples, the interacting with the management virtual security processor includes sending a management command to the management virtual security processor through the interface.

In some examples, the interacting with the management virtual security processor includes receiving a management object from the management virtual security processor through the interface.

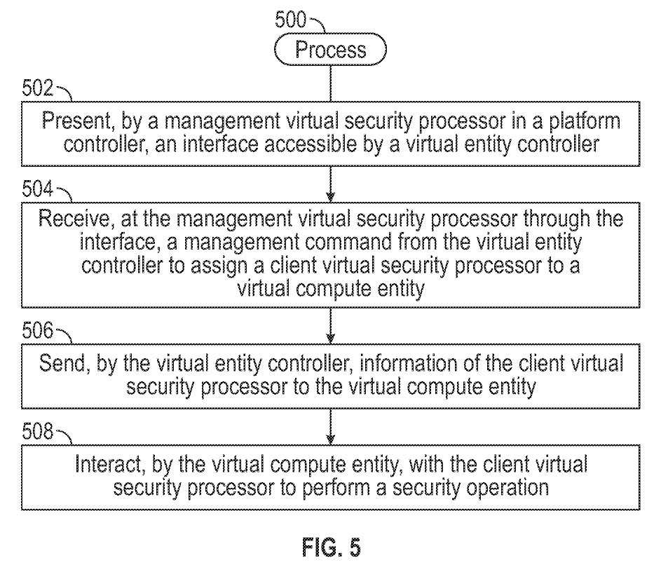

FIG. 5 is a flow diagram of a process 500 according to some examples of the present disclosure. The process 500 may be performed in the computer system 100 of FIG. 1A or computer system 160 of FIG. 1B, for example.

The process 500 includes presenting (at 502), by a management virtual security processor in a platform controller, an interface accessible by a virtual entity controller. For example, a management vTPM can present a management API.

The process 500 includes receiving (at 504), at the management virtual security processor through the interface, a management command from the virtual entity controller to assign a client virtual security processor to a virtual compute entity. The management command may be the create command, the start command, or another command discussed further above.

The process 500 includes sending (at 506), by the virtual entity controller, information of the client virtual security processor to the virtual compute entity. The information may include a BAR base address and a number of the client virtual security processor (e.g., a VF number).

The process 500 includes interacting (at 508), by the virtual compute entity, with the management virtual security processor to perform a security operation. The security operation includes attesting the virtual compute entity.

Examples of computers can include any of the following: a desktop computer, a notebook computer, a tablet computer, a server computer, a printing system, a storage appliance, a communication node, a vehicle, and so forth.

A memory device can be implemented using one or more memory devices. A memory device can include any or some combination of a dynamic random access memory (DRAM) device, a static random access memory (SRAM) device, a flash memory device, an erasable and programmable read-only memory (EPROM), an electrically erasable and programmable read-only memory (EEPROM), or another type of memory device.

As used here, a "controller" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a "controller" can refer to a combination of one or more hardware processing circuits and machine-readable instructions (software and/or firmware) executable on the one or more hardware processing circuits.

FIGS. 2 and 5 are flow diagrams of processes including tasks performed in depicted orders. In other examples, the tasks of any of the processes may be performed in a different order, some of the tasks may be omitted, and other tasks may be added.

A "BMC" can refer to a specialized service controller that monitors the physical state of a computer system using sensors and communicates with a remote management system (that is remote from the computer system) through an independent "out-of-band" connection. The BMC can perform management tasks to manage components of the computer system. Examples of management tasks that can be performed by the BMC can include any or some combination of the following: power control to perform power management of the computer system (such as to transition the computer system between different power consumption states in response to detected events), thermal monitoring and control of the computer system (such as to monitor temperatures of the computer system and to control thermal management states of the computer system), fan control of fans in the computer system, system health monitoring based on monitoring measurement data from various sensors of the computer system, remote access of the computer system (to access the computer system over a network, for example), remote reboot of the computer system (to trigger the computer system to reboot using a remote command), system setup and deployment of the computer system, system security to implement security procedures in the computer system, and so forth.

In some examples, the BMC can provide so-called "lights-out" functionality for the computer system. The lights out functionality may allow a user, such as a systems administrator, to perform management operations on the electronic device even if an OS is not installed or not functional on the computer system.

Moreover, in some examples, the BMC can run on auxiliary power provided by an auxiliary power source; as a result, the computer system does not have to be powered on to allow the BMC to perform the BMC's operations. The auxiliary power source is separate from a primary power supply that supplies powers to other components (e.g., a main processor, a memory, an I/O device, etc.) of the computer system.

A storage medium (e.g., 400 in FIG. 4) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A platform controller comprising:
a processing resource; and
a management virtual security processor executable by the processing resource to:
present an interface accessible to a virtual entity controller in a computer system, the computer system comprising a central processing unit (CPU) separate from the platform controller, the virtual entity controller to manage a virtual compute entity in the computer system; and
interact with the virtual entity controller through the interface to perform a management task related to a client virtual security processor for the virtual compute entity.

2. The platform controller of claim 1, wherein the management virtual security processor executable by the processing resource to:
receive, from the virtual entity controller, a management command relating to assigning the client virtual security processor to or unassigning the client virtual security processor from the virtual compute entity; and
in response to the management command, assign the client virtual security processor to or unassign the client virtual security processor from the virtual compute entity.

3. The platform controller of claim 1, wherein the management virtual security processor executable by the processing resource to:
receive, from the virtual entity controller, a management command relating to loading state information to or unloading state information from the client virtual security processor; and
in response to the management command, load the state information to or unload the state information from the client virtual security processor.

4. The platform controller of claim 3, wherein the state information comprises a cryptographic key used by the client virtual security processor.

5. The platform controller of claim 3, wherein the state information comprises one or more of a measurement value for use in attesting an electronic component of the computer system, or instance metadata for the virtual compute entity.

6. The platform controller of claim 1, wherein the management virtual security processor executable by the processing resource to:
receive, from the virtual entity controller, a management command relating to creating the client virtual security processor or removing the client virtual security processor in the platform controller; and
in response to the management command, create or remove the client virtual security processor in the platform controller.

7. The platform controller of claim 1, wherein the management virtual security processor is executable by the processing resource to:
send, to the virtual entity controller, a management object comprising updated state information of the client virtual security processor.

8. The platform controller of claim 7, wherein the updated state information in the management object sent to the virtual entity controller is encrypted.

9. The platform controller of claim 1, wherein the management virtual security processor executable by the processing resource to:
send, to the virtual entity controller, a management object comprising an indicator that state information of the client virtual security processor has been updated.

10. The platform controller of claim 1, wherein the interface comprises an application programming interface (API).

11. The platform controller of claim 1, wherein the virtual entity controller comprises a hypervisor and the virtual compute entity comprises a virtual machine (VM).

12. The platform controller of claim 1, wherein the management virtual security processor comprises a management virtual trusted platform module (vTPM).

13. The platform controller of claim 1, wherein the management virtual security processor is part of a Peripheral Component Interconnect (PCI) physical function (PF) of the platform controller.

14. The platform controller of claim 1, wherein the management virtual security processor is part of an Enhanced Serial Peripheral Interface (eSPI) endpoint of the platform controller.

15. A non-transitory machine-readable storage medium comprising instructions that upon execution cause a system to:
detect a management virtual security processor executed by a platform controller that is separate from a central processing unit (CPU) executing a virtual compute entity;
interact with the management virtual security processor through an interface presented by the management virtual security processor to assign a client virtual security processor in the platform controller to the virtual compute entity; and
send, to the virtual compute entity, information of the management virtual security processor to allow the virtual compute entity to interact with the management virtual security processor for a security operation.

16. The non-transitory machine-readable storage medium of claim 15, wherein the detecting of the management virtual security processor, the interacting with the management virtual security processor, and the sending of the information to the virtual compute entity are performed by a hypervisor.

17. The non-transitory machine-readable storage medium of claim 15, wherein the interacting with the management virtual security processor comprises sending a management command to the management virtual security processor through the interface.

18. The non-transitory machine-readable storage medium of claim 15, wherein the interacting with the management virtual security processor comprises receiving a management object from the management virtual security processor through the interface.

19. A method comprising:
presenting, by a management virtual security processor in a platform controller, an interface accessible by a virtual entity controller;
receiving, at the management virtual security processor through the interface, a management command from the virtual entity controller to assign a client virtual security processor to a virtual compute entity;
sending, by the virtual entity controller, information of the client virtual security processor to the virtual compute entity; and
interacting, by the virtual compute entity, with the management virtual security processor to perform a security operation.

20. The method of claim 19, further comprising:
sending, from the management virtual security processor through the interface, a management object containing updated state information of the client virtual security processor.
